(19) United States
(12) Patent Application Publication
(10) Pub. No.: US 2004/0161993 A1
(43) Pub. Date: Aug. 19, 2004

(54) Inorganic fiber insulation made from glass fibers and polymer bonding fibers

(76) Inventors: Gary Tripp, Corbin, KY (US); Alain Yang, Bryn Mawr, PA (US); Mark Trabbold, Harleysville, PA (US)

Correspondence Address: DUANE MORRIS, LLP, IP DEPARTMENT, ONE LIBERTY PLACE, PHILADELPHIA, PA, 19103-7396, US

(21) Appl. No.: 10/782,275

(22) Filed: Feb. 19, 2004

Related U.S. Application Data
(63) Continuation-in-part of application No. 10/689,858, filed on Oct. 21, 2003.
(63) Continuation-in-part of application No. 09/946,476, filed on Sep. 6, 2001.
(63) Continuation-in-part of application No. 10/766,052, filed on Jan. 28, 2004.

(51) Int. Cl. B65B 1/00; B31B 1/60; B65C 1/00; B32B 5/24; B32B 5/18; B32B 31/00; D04H 1/00; D04H 5/00; D04H 3/00; D04H 13/00; B32B 5/26; B32B 15/14; B32B 27/12

(52) U.S. Cl. 442/341; 442/347; 442/348; 442/351; 442/364; 442/378; 442/381; 442/394; 156/60

(57) ABSTRACT

An inorganic fiber composite insulation batt is fabricated from mineral or inorganic fibers, preferably from scrap, and plastic-containing bonding fibers. The inorganic fiber composite insulation batt has substantially uniform density throughout its volume. The plastic-containing bonding fibers are used as the binder in this formulation.

### CROSS REFERENCE TO RELATED APPLICATIONS

This application is a continuation-in-part of the following copending United States patent applications: U.S. patent application Ser. No. 10/689,858, filed on Oct. 22, 2003, U.S. patent application Ser. No. 09/946,476, filed on Sep. 6, 2001, and U.S. patent application Ser. No. 10/766,052, filed on Jan. 28, 2004, which are commonly assigned and hereby incorporated by reference.

This application is also related to U.S. Pat. No. 6,673,280, issued Jan. 6, 2004, and U.S. patent application Ser. No. ______, filed on Feb. 18, 2004, for FORMALDEHYDE-FREE DUCT LINER, which are also commonly assigned and hereby incorporated by reference.

### FIELD OF THE INVENTION

The present invention relates to fiber glass insulation material and, more particularly, to fiber glass composite insulation preferably made from scrap rotary glass fibers and plastic-containing bonding fibers without the use of conventional resin binders. The composite insulation is especially suited for building insulation.

### BACKGROUND OF THE INVENTION

Conventional bindered fiber glass insulation products in general are fabricated by bonding together glass fibers with binders, such as a phenol/formaldehyde resin binder, to form batts or blankets of the fiber insulation material. Sometimes, a mixture of glass fibers and synthetic fibers are bonded together. One such product having both glass fibers and synthetic fibers, and manufactured by a textile non-woven process, is disclosed in U.S. Pat. No. 4,751,134 to Chenoweth et al. In another example, the organic binder material in aqueous form is sprayed on to a continuously fed blanket of glass fibers which is cured and sized into insulation batts.

One of the problems associated with applying aqueous organic binders of the prior art to cylindrical veils or blankets of glass fibers is that some of the binder material is lost through evaporation during the spraying process. The evaporated binder material becomes an air borne contaminant in the exhaust air stream of the process and must be cleaned up in order to avoid pollution problems. Also, the binder material is generally sticky and requires extensive cleaning of the manufacturing equipment, such as the fiber collection apparatus, to prevent the build-up of clumps of glass fiber insulation material which can drop into the product and cause a product defect.

Another problem associated with the use of organic resin binders such as phenol/formaldehyde resin binder material is that they require a high temperature curing process. The curing temperature for organic resin binders are typically in the range of about 200 to 300° C. This usually results in high manufacturing costs driven by the capital and operating cost of curing ovens, the cost of handling air pollution problems. If higher molecular weight polymers could be applied to glass fibers to produce insulation products, some benefits could be realized. In view of the manufacturing and environmental costs, it would be beneficial to be able to reduce or eliminate the use of organic binder materials.

In one example of a glass fiber insulation material disclosed in U.S. Pat. No. 5,983,586 to Berdan, II et al., spinners are used to generate a cylindrical veil of virgin rotary glass fibers and an array of polymer fibers are simultaneously produced using one or more of polymer fiber dies. The polymer fibers are directed on to the veil of glass fibers and collected as a direct formed pack. The direct formed pack is then heated to a temperature close to the melting point of the polymer fibers so that they become sufficiently soft to bond the glass fibers together. The polymer fibers are thermoplastic polymers whose melting point is lower than the curing temperature of the traditional phenol/formaldehyde resin binders. The melting point of polymer fibers used in such application is typically in the range of about 150° C. Using the fiberizing process of this example, however, uniformly mixing the glass fibers and the polymer fibers is difficult.

Thus, there is a need for improved glass fiber/polymer fiber composite insulation material that does not require the use of any conventional phenol/formaldehyde resin binder. Also, it would be advantageous if the improved fiber glass insulation material has improved thermal insulation properties and good handleability for application in building insulation.

The above-mentioned need along with another need in the insulation industry to recycle scrap insulation materials are addressed by the present invention disclosed herein.

### SUMMARY OF THE INVENTION

According to an aspect of the present invention, inorganic fiber composite insulation material made from mineral or inorganic fibers and plastic-containing bonding fibers, with or without using conventional resin binders, and a method of fabricating such insulation material are disclosed.

In a preferred embodiment of the present invention, the mineral or inorganic fibers may be scrap glass insulation fibers such as scrap rotary glass fibers or scrap textile fibers. The glass fibers and plastic-containing bonding fibers are uniformly blended together into a mat. The plastic-containing bonding fibers act as the binding agent in the composite fiber mixture and the mat is heated in a curing or heating oven to an elevated temperature that is sufficiently high to soften and/or partially melt a portion of the plastic of the plastic-containing bonding fibers. Thus, the plastic-containing bonding fibers bond at least a portion of the glass fibers together to form a final mat.

In another embodiment of the present invention, the mineral or inorganic fibers may be virgin rotary glass fibers such as loose fill InsulSafe®4 fiber glass blowing insulation available from CertainTeed Corp. of Valley Forge, Pa., or virgin textile fibers that have been cut to appropriate lengths.

The plastic-containing bonding fibers are preferably thermoplastic polymer fibers, or thermosetting fibers, having melt bonding or chemical bonding properties prior to final curing, and they may be mono-component, bi-component, or mixtures thereof. The mono-component polymeric fibers are preferably solid or tubular fibers of a single polymeric material. The bi-component polymeric fibers may be of the sheath-core construction wherein the sheath material has a lower melting point than the core material. The bi-component polymeric fibers may also be of other constructions. For example, the two components may have side-by-side or segmented pie construction in cross section. Additionally, plastic coated mineral fibers, such as thermoplastic-coated glass fibers may also be used.

According to another aspect of the present invention, inorganic fiber composite insulation products, such as batts or blankets, made from mineral or inorganic fibers and plastic-containing bonding fibers with or without using conventional resin binders, and a method of fabricating such insulation products are disclosed.

The insulation product comprises a fiber mat having a first side and a second side and comprising loose fiber insulation-type glass fibers and plastic-containing bonding fibers. The glass fibers and the plastic-containing bonding fibers are uniformly blended together to form a blended layer having a substantially uniform density throughout its volume, wherein the plastic-containing bonding fibers bond at least a portion of the glass fibers together. Generally, a facing layer of vapor barrier is bonded to at least one of the two sides of the fiber mat to form an insulation product. A vapor barrier may be made of polyethylene film, kraft paper, kraft paper coated with asphalt, foil, foil-backed paper, foil-backed paper coated with asphalt, or foil-scrim-kraft paper. The facing layer may also be a fabric layer for improving the strength and handleability of the insulation material during installation and dust reduction. The fabric layer may be made from, for example, scrim, woven, non-woven, knit, braided, needled, or composite fabrics.

The inorganic fiber insulation material and insulation products made from the insulation material according to the present invention has a substantially uniform density throughout its volume.

In another embodiment of the present invention, a method of making the fiber glass insulation blanket is disclosed. In this method, mineral or inorganic fibers and plastic-containing bonding fibers provided in bulk form, such as bales, are opened to obtain desired fiber sizes. The opened fibers are then evenly blended and formed into a blended layer or a mat having a first side and a second side. Generally, a facing layer of vapor barrier is applied to at least one of the two sides of the mat. The mat is then cured or heated to form the fiber glass insulation blanket. Whether the mat is just heated or cured depends on whether the binding agents used, the plastic-containing binding fibers, is a thermoplastic type or a thermosetting type. The blanket may be further cut and sized into batts. The insulation products made according to the present invention has an R-value of about 2.0 to 3.5 per inch.

The use of scrap rotary fibers reduces manufacturing cost because the cost of the raw material is less expensive than virgin glass fibers and additional cost savings may be realized by elimination of the cost of sending the scrap rotary fibers to landfill. In addition, recycling of the scrap rotary fibers provides an environmentally friendly alternative to discarding the scrap fibers in landfills. Also, in an embodiment of the present invention where virgin glass fibers are used, the final product has the beneficial characteristic of being substantially formaldehyde-free because the plastic-containing bonding fibers are used as the bonding agent without the use of any formaldehyde-containing resin binders.

### BRIEF DESCRIPTION OF THE DRAWINGS

FIG. 1 is an elevational view of an exemplary embodiment of an insulation batt made from the inorganic fiber insulation material according to an aspect of the present invention;

FIG. 2 is a schematic illustration of an apparatus for forming the inorganic fiber insulation material of the present invention;

FIG. 3a-3c are detailed schematic illustrations of bale openers that are part of the apparatus of FIG. 2;

FIG. 4 is a detailed schematic illustration of another section of the apparatus of FIG. 2;

FIG. 5 is a flow chart diagram of a process for forming the exemplary insulation batt of FIG. 1; and

FIG. 6 is a plot of the thermal conductivity (K-value) of samples of inorganic fiber insulation mats prepared according to an embodiment of the present invention as a function of the density of the mats shown in comparison to the thermal conductivity of the same glass fibers in loose fill form.

The features shown in the above referenced drawings are not intended to be drawn to scale nor are they intended to be shown in precise positional relationship. Like reference numbers indicate like elements.

### DETAILED DESCRIPTION OF THE INVENTION

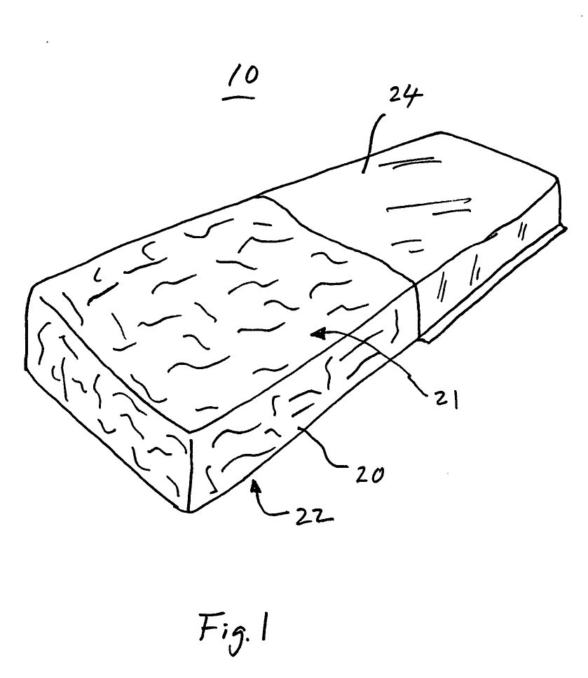

FIG. 1 is an elevational view of an exemplary building insulation batt 10 comprising a section of a fiber mat 20 having a first side 21, a second side 22 and encapsulated in a facing layer 24. The building insulation batts and blankets may be utilized without any facing but in most building insulation applications, insulation products with facing layers already bonded are used. The facing layer may be a vapor barrier such as polyethylene film, kraft paper, kraft paper coated with asphalt, foil, foil-backed paper, foil-backed paper coated with asphalt, or foil-scrim-kraft paper that is strong and also flame-resistant. The facing layer may also be a fabric layer for improving the strength, the handleability of the insulation batt during installation and dust reduction. Some examples of the fabric facing layer are, scrim, woven, non-woven, knit, braided, needled, or composite fabrics.

The fiber mat 20 is formed from a mixture of mineral or inorganic fibers and plastic-containing bonding fibers and may have a density of about 24 to 48 kg/m³. The density of the fiber mat is substantially uniform throughout its volume. The gram weight of the fiber mat 20 is in the range of about 310 to 2100 gm/m². The thickness of the fiber mat 20 may be fabricated to be in the range of about 13 to 89 mm. However the thickness, density, and gram weight of a particular insulation batt is influenced by the levels of acoustic and/or thermal insulation that are desired or necessary for a particular building installation application.

In this embodiment of the inorganic fiber insulation material according to the present invention, the facing layer 24 encapsulates the fiber mat 20. However, depending on the need of the particular application and the end-user, facing layer need not be bonded to all sides of the fiber mat 20. But, generally, at least one of the two sides of the fiber mat 20 will have a facing layer 24 as a vapor barrier in the final product form.

In a preferred embodiment of the present invention, the mineral or inorganic fibers may be glass fibers and more preferably scrap rotary glass fibers and/or other scrap unbindered glass insulation fibers such as those used in loose fill application. The use of the scrap glass fibers provides a low-cost solution to making fiber glass insulation product by recycling the scrap fibers. The glass fibers may have an average diameter of about 1 to 10 micrometers and preferably about 2 to 5 micrometers. The glass fibers may have average fiber length not greater than about 250 mm and preferably not greater than about 127 mm. The glass fibers make up about 70 to 90 wt. % of the composite insulation mat.

In another embodiment of the present invention the mineral or inorganic fibers may be virgin rotary fibers or virgin or scrap textile fibers. An example of suitable virgin rotary fibers is loose fill InsulSafe®4 fiber glass blowing insulation available from CertainTeed Corp. of Valley Forge, Pa.

The glass fibers and plastic-containing bonding fibers are uniformly blended together into a mat, wherein the plastic-containing bonding fibers act as the binding agent. The mat is heated in a curing or heating oven to a temperature that is sufficiently high to soften and/or partially melt the plastic-containing bonding fibers and bond at least a portion of the glass fibers together into a final mat.

The plastic-containing bonding fibers used as the binder in the composite insulation material of the present invention may be bi-component polymeric fibers, mono-component polymeric fibers, plastic-coated mineral fibers, such as, thermoplastic-coated glass fibers, or a combination thereof. The bi-component polymeric fibers are commonly classified by their fiber cross-sectional structure as side-by-side, sheath-core, islands-in-the sea and segmented-pie cross-section types. In a preferred embodiment of the present invention, the sheath-core type bi-component polymer fibers are used.

The bi-component polymeric fibers have a core material covered in a sheath material that has a lower melting temperature than the core material. Both the core and the sheath material may be a thermoplastic polymer such as, for example, polyethylene, polypropylene, polyester, polyethylene teraphthalate, polybutylene teraphthalate, polycarbonate, polyamide, polyvinyl chloride, polyethersulfone, polyphenylene sulfide, polyimide, acrylic, fluorocarbon, polyurethane, or other thermopolastic polymers. The core and the sheath materials each may be made of different thermoplastic polymers or they may be made of the same thermoplastic polymer but of different formulation so that the sheath material has lower melting point than the core material. Additionally, thermosetting resins can be employed prior to final curing or heating of the mat. Typically, the sheath material can be formulated to melt at various temperatures from about 110° to 220° Centigrade. The melting point of the core material is typically about 260° Centigrade. The bi-component polymeric fibers used in the present invention may have an average fiber diameter of about 10 to 20 micrometers and preferably about 16 micrometers. The average length of the bi-component plastic-containing bonding fibers is between about 6.3 to 127 mm and preferably between about 51 to 102 mm. The plastic-containing bonding fibers may make up about 10 to 30 wt. % of the insulation material.

If higher strength is desired in the final product, concentric type sheath-core bi-component polymer fibers may be used. If bulkiness is desired in the final product, eccentric type sheath-core bi-component polymer fibers may be used.

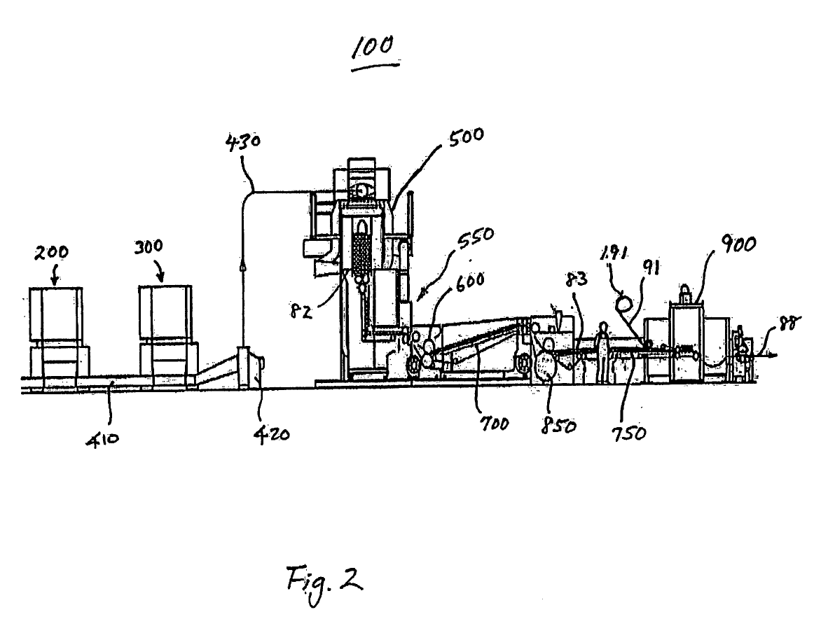

The inorganic fiber insulation of the present invention may be produced in accordance with air-laid processing steps generally known in the art. The particular configuration of the fabrication apparatus used, however, may vary. As an example, an air laid process that may be employed in fabricating an inorganic fiber insulation mat according to an embodiment of the present invention will now be described. In a preferred method of forming the insulation mat of the present invention, an air laid non-woven process equipment available from DOA (Dr. Otto Angleitner G.m.b.H. & Co. KG, A-4600 Wels, Daffingerstasse 10, Austria), equipment 100 illustrated in FIGS. 2-5, may be used. In this example, an inorganic fiber insulation material is formed by blending scrap rotary glass fibers with bi-component polymer fibers as the binder. As illustrated in FIG. 2, the apparatus 100 includes bale openers 200 and 300, one for each type of fibers. The scrap rotary glass fibers are opened by the bale opener 200 and the bi-component polymer fibers are opened by the bale opener 300.

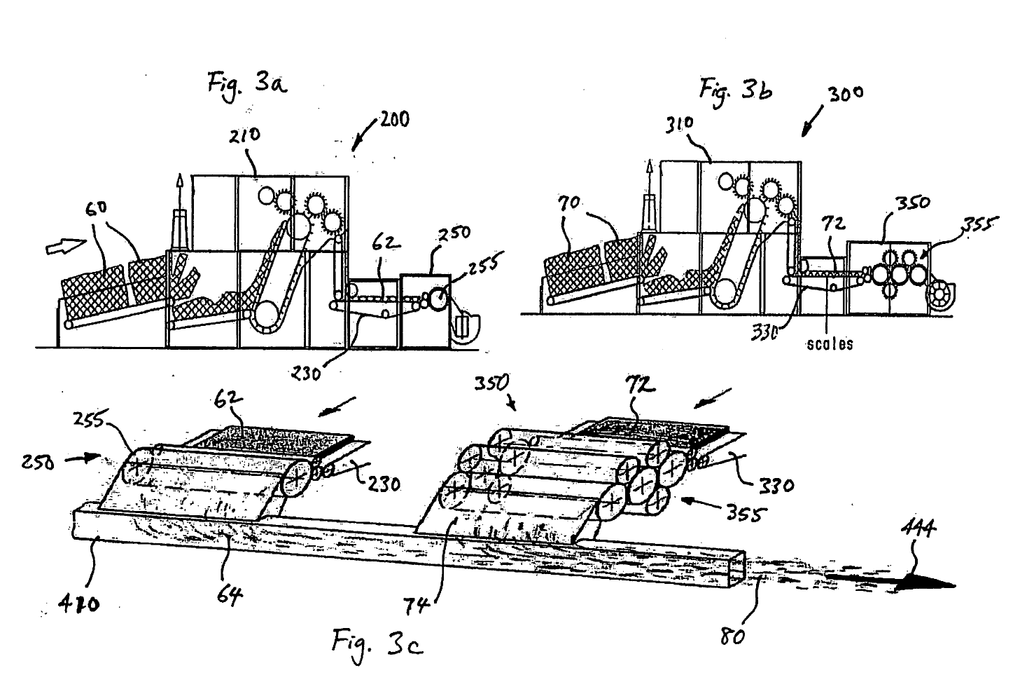

FIG. 3a is a detailed illustration of the bale opener 200. The scrap rotary glass fibers are provided in bulk form as bales 60. The bales 60 are fed into the bale opener which generally comprise coarse opener 210 and a fine opener 250. The scrap rotary glass fibers 60 are coarsely opened by the coarse opener 210 and weighed by an opener conveyor scale 230. The opener conveyor scale 230 monitors the amount of opened glass fibers being supplied to the process by continuously weighing the supply of the opened glass fibers 62 as they are being conveyed. Next, the coarsely opened glass fibers are finely opened by the fine opener's picker 255. The opening process fluffs up the fibers to decouple the clustered fibrous masses in the bales and enhances fiber-to-fiber separation.

FIG. 3b is a detailed illustration of the bale opener 300. The bi-component polymer fibers are provided in bulk form as bales 70. The bales 70 are fed into the bale opener 300. The polymer fibers 70 are first opened by a coarse opener 310 and weighed by an opener conveyor scale 330. The opener conveyor scale 330 monitors the amount of the opened plastic-containing bonding fibers being supplied to the process by continuously weighing the supply of the opened polymer fibers 72. Next, the coarsely opened polymer fibers are finely opened by the fine opener 350 and its pickers 355. For illustrative purpose, the fine opener 350 is shown with multiple pickers 355. The actual number and configuration of the pickers would depending on the desired degree of separation of the opened fibers into individual fibers. The bale openers 200 and 300 including the components described above may be provided by, for example, DOA's Bale Opener model 920/920TS.

Illustrated in FIG. 2 is a pneumatic transport system for transporting the opened fibers from the bale openers 200 and 300 to the subsequent processing stations of the apparatus 100. The pneumatic transport system comprises a transport conduit 410 in which the opened fibers are blended; an air blower 420; and a second transport conduit 430 for transporting the blended fibers up to the fiber condenser 500.

FIG. 3c illustrates opened scrap rotary glass fibers 64 and opened bi-component polymer fibers 74 being discharged into the first transport conduit 410 from their respective fine openers 250 and 350. The airflow in the first transport conduit 410 generated by the air blower 420 is represented by the arrow 444. The opened fibers 64 and 74 enters the air stream and are blended together into blended fibers 80. The ratio of the glass fibers and the bi-component polymer fibers are maintained and controlled at a desired level by controlling the amount of the fibers being opened and discharged by the bale openers using the opener conveyor scales 230 and 330. As mentioned above, the conveyor scales 230, 330 continuously weigh the opened fiber supply for this purpose. In this example, the fibers are blended in a given ratio to yield the final insulation mat containing about 10 to 30 wt. % of the plastic-containing bonding fibers.

Although one opener per fiber component is illustrated in this exemplary process, the actual number of bale openers utilized in a given process may vary depending on the particular need. For example, one or more bale openers may be employed for each fiber component.

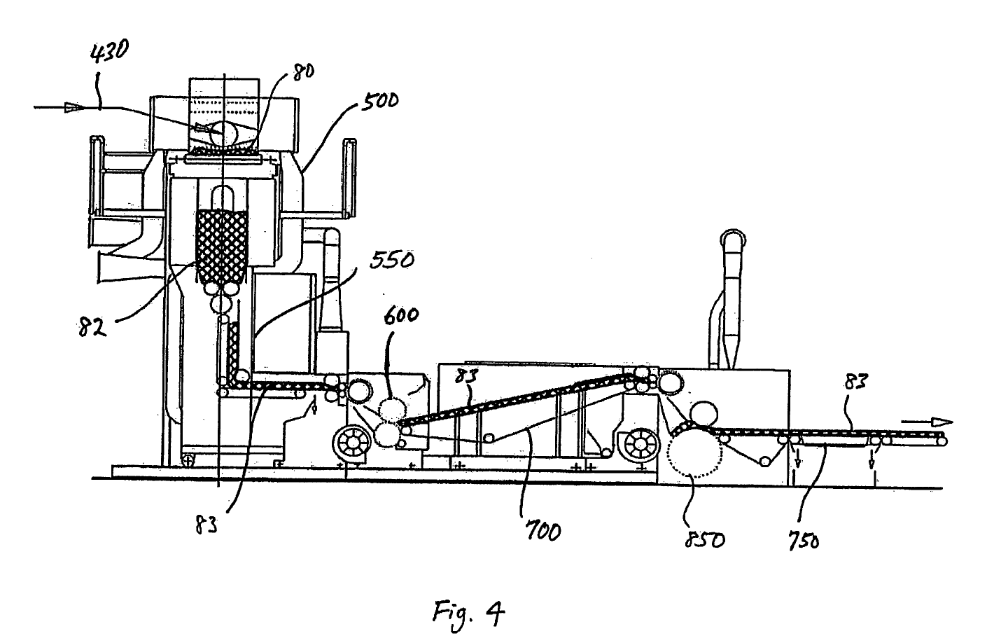

The blended fibers 80 are transported by the air stream in the pneumatic transport system via the second transport conduit 430 to a fiber condenser 500. Referring to FIG. 4, the fiber condenser 500 condenses the blended fibers 80 into less airy fiber blend 82. The condensing process only separates air from the blend without disrupting the uniformity (or homogeneity) of the blended fibers. The fiber blend 82 is then formed into a continuous sheet of mat 83 by the feeder 550 on to a conveyor. At this point, the mat 83 may be optionally processed through a sieve drum sheet former 600 to adjust the openness of the fibers in the mat 83. The mat 83 is then transported by another conveyor scale 700 during which the mat 83 is continuously weighed to ensure that the flow rate of the blended fibers through the fiber condenser 500 and the feeder 550 is at a desired rate. The conveyor scale 700 is in communication with the first set of conveyor scales 230 and 330 in the bale openers. Through this feed back loop set up, the weight of the opened fibers measured at the conveyor scales 230 and 330 are compared to the weight of the mat 83 measured at the conveyor scale 700 to determine whether the amount of the opened fibers being fed into the process at the front end matches the rate at which the mat 83 is being formed at the feeder 550. Thus, the feed back loop set up effectively compares the feed rate of the opened fibers and the flow rate of the blended fibers through the feeder 550 and adjusts the speed of the bale openers and the rate at which the bales are being fed into the openers. This ensures that the bale openers 200 and 300 are operating at appropriate speed to meet the demand of the down stream processing. This feed back loop set up is used to control and adjust the feed rate of the opened fibers and the line speed of the conveyor scale 700 which are the primary variables that determine the gram weight of the mat 83. The air laid non-woven process equipment 100 may be provided with an appropriate control system (not shown), such as a computer, that manages the operation of the equipment including the above-mentioned feed back loop function.

A second sieve drum sheet former 850 may be used to further adjust the fibers' openness before curing or heating the mat 83. A conveyor 750 then transports the mat 83 to a curing or heating oven 900 (FIG. 2). For example, the condenser 500, feeder 550, sieve drum sheet former 600, conveyor scale 700, and the second sieve drum sheet former 850 may be provided using DOA's Aerodynamic Sheet Forming Machine model number 1048.

In one embodiment of the present invention, a continuous web of facing layer 91 may be dispensed from a roll 191 and is applied to at least one surface of the mat 83 before the mat 83 enters the curing or heating oven 900. The facing layer 91 may function as a vapor retarder for the finished insulation product, such as a batt or a blanket. The particular material chosen for the facing layer 91 in this example, must be able to survive the curing temperature.

After the facing layer 91 is applied, the mat 83 is then fed into a curing or heating oven 900 to cure or heat the plastic-containing bonding fibers. The curing or heating oven 900 is a belt-furnace type. The curing or heating temperature is generally set at a temperature that is higher than the curing or melting-temperature of the binder material. In this example, the curing or heating oven 900 is set at a temperature higher than the melting point of the sheath material of the bi-component polymeric fibers but lower than the melting point of the core material of the bi-component polymeric fibers. In this example, the bi-component polymer fibers used is Celbond type 254 available from KoSa of Salisbury, N.C., whose sheath has a melting point of 110° C. And the curing or heating oven 90 temperature is preferably set to be somewhat above the melting point of the sheath material at about 145° C. The sheath component will melt and bond at least a portion of the glass fibers and the remaining core filament of the bi-component polymeric fibers together into a final mat 88 having a substantially uniform density throughout its volume. Preferably, the plastic-containing bonding fibers are in sufficient quantity in the mat 83 to bond the facing layer 91 to the mat without using any additional adhesive or bonding agent. The core component of the bi-component polymeric fibers in the final mat 88 provide reinforcement for the insulation product formed from the final mat 88.

In another embodiment of the present invention, the curing or heating oven 900 may be set to be at about or higher than the melting point of the core component of the bi-component polymeric fiber. This will cause the bi-component fibers to completely or almost completely melt and serve generally as a binder without necessarily providing reinforcing fibers. Because of the high fluidity of the molten plastic fibers, the glass fiber mat will be better covered and bounded. Thus, less plastic-containing bonding fibers may be used.

In another embodiment of the present invention, mono-component polymeric fibers may be used as the binder rather than the bi-component polymeric fibers. The mono-component polymeric fibers used for this purpose may be made from the same polyolefin thermoplastic polymers as the bi-component polymeric fibers. The melting point of various thermoplastic polymers will vary and the temperature of the oven will be set appropriately for the particular mono-component polymeric fiber chosen. Generally, the mono-component polymeric fibers will completely or almost completely melt during the curing process step and bind the glass fibers.

In yet another embodiment of the present invention, plastic-coated glass fibers may be used as the bonding fibers instead of, or in combination with, the bi-component polymer fibers. Still in another embodiment of the present invention, scraps of commingled glass and thermoplastic fibers such as Twintex® available from Saint-Gobain Vetrotex International, S.A. may be used as the mineral fiber component, the bonding fiber component, or used in combination with other mineral fibers and the plastic-containing bonding fibers.

After the curing and/or heating step, a series of finishing operations may be performed. The final mat 88 exiting the curing or heating oven 900 is cooled in a cooling section (not shown) and cut to desired sizes as insulation batts. The edges of the mat may be cut to a desired width.

In another embodiment of the present invention, the facing layer, especially if the facing material can not survive the curing temperature, may be bonded to at least one side of the insulation mat after the curing or heating step and then cut to size.

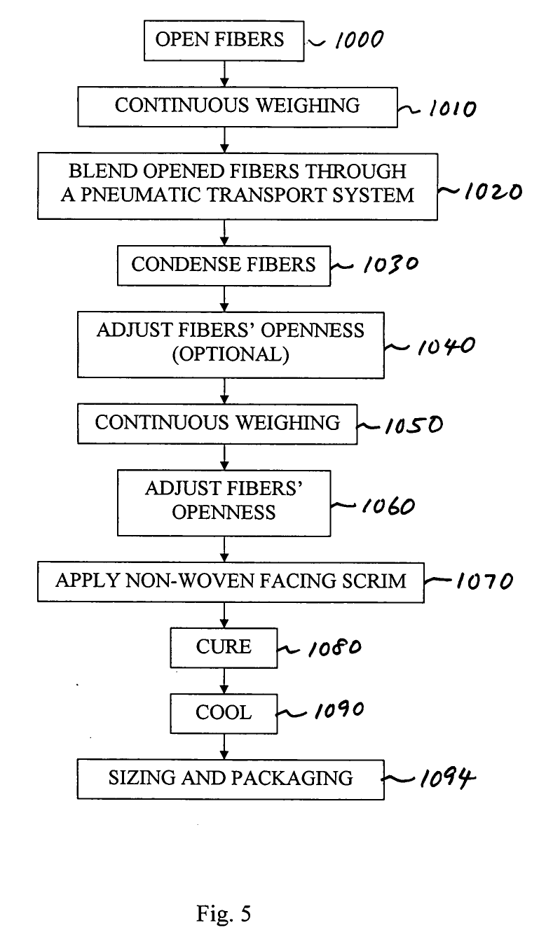

FIG. 5 is a flow chart diagram of the exemplary process.

At step 1000, the bales of the mineral or inorganic fibers and plastic-containing bonding fibers are opened using bale openers.

At step 1010, the opened fibers are weighed continuously by one or more conveyor scale(s) to monitor the amount of fibers being opened to control the amount of each type of fibers being supplied to the process ensuring that the fibers are being blended in a proper ratio.

At step 1020, the opened fibers are blended and transported to the fiber condenser by a pneumatic transport system which blends and transports the opened fiber(s) in an air stream through a conduit.

At step 1030, the opened fibers are condensed into less airy fiber blend and formed into a continuous sheet or a mat of fibers and uniformly laid out on to a conveyor.

At step 1040, the condensed fiber blend is optionally processed through a sieve drum sheet former to adjust the openness of the fibers in the uncured mat.

At step 1050, the uncured mat is continuously weighed by a conveyor scale to ensure that the flow rate of the blended fibers through the fiber condenser and the sheet former is at a desired rate. The information from this conveyor scale is fed back to the first set of conveyor scale(s) associated with the bale openers to control the bale opener(s) operation. The conveyor scales ensure that a proper supply and demand relationship is maintained between the bale opener(s) and the fiber condenser and sheet former.

At step 1060, the fibers' openness may be further adjusted by a second sieve drum sheet former.

At step 1070, a facing layer may be applied to at least one side of the mat before the curing or heating step.

At step 1080, the mat is cured or heated in a belt-furnace type curing or heating oven into a final mat. The curing oven is set at a temperature appropriate for curing or heating the particular plastic-containing bonding fibers used. Generally, this temperature will be somewhat higher than the curing or melting temperature of the bonding fibers.

At step 1090, the final mat is cooled.

At step 1094, the final mat is cut to desired sizes and packaged for shipping.

The use of the plastic-containing bonding fibers as the binder rather than the conventional resin binders is beneficial for a number of reasons. Because the curing or melting temperature for plastic-containing bonding fibers is generally lower than that of the conventional phenol resin binders, the manufacturing process associated with the glass fiber composite insulation mat of the present invention consumes less energy. For example, the curing or heating ovens used in the manufacturing process described above in reference to FIGS. 3-4, are set to be less than about 200° C. and preferably at about 145° C. rather than about 205° C. or higher typically required for curing phenol resin binders. Also, because of the absence of formaldehyde out gassing from the binder material during the fabrication process, there is no need for special air treatment equipment to remove formaldehyde from the curing oven's exhaust. These advantages translate into lower manufacturing cost and less air pollution.

Furthermore, unlike the thermosetting phenol resin binders, that are rigid and brittle when cured, the plastic-containing bonding fibers are thermoplastic polymers and are more flexible and less likely to crack and generate dust through handling. Thus, less dust is generated during the production of the composite insulation mat as well as at the job sites where the insulation batts are installed.

The color of the basic insulation mat as produced from the above-described process is generally white. The color may be easily customized by adding appropriate coloring agents, such as dyes or colored pigments.

### EXAMPLES

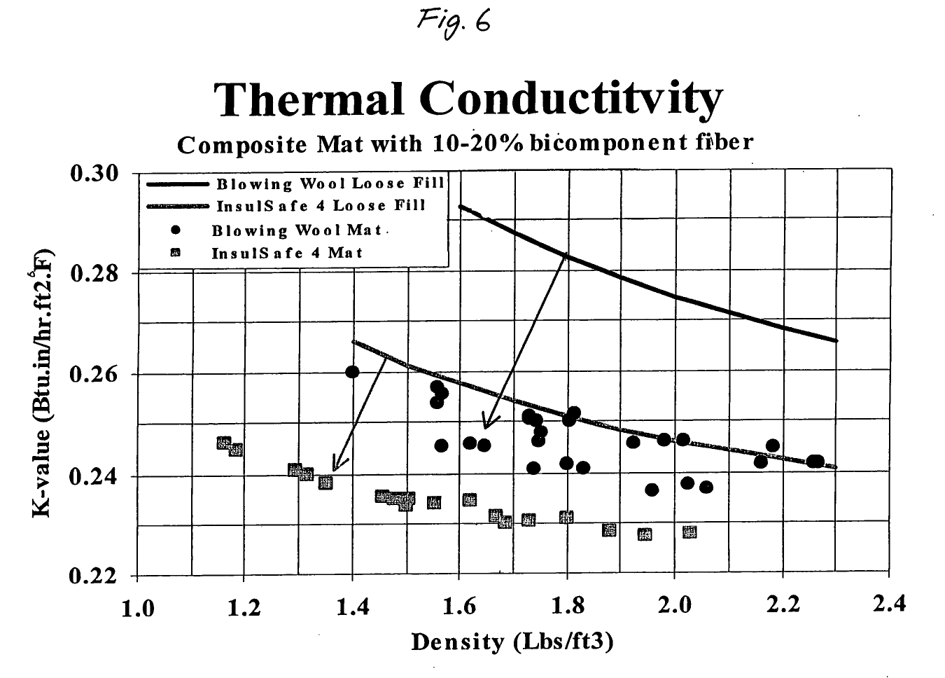

Several samples of the inorganic fiber insulation mats were prepared from scrap rotary glass fibers and loose fill Insulsafe®4 glass fibers according to the process described herein. The thermal insulation properties of the samples were compared to those of the starting loose fill glass fiber material. The results are shown in the plot presented in FIG. 6.

The inorganic fiber insulation material of the present invention provides cost savings from being able to recycle scrap rotary fibers. Another benefit realized in an embodiment of the present invention that uses bi-component polymer fiber as the bonding fibers is that the insulation mat has a high tensile strength attributable to the reinforcement effect of the core component of the bi-component plastic fiber.

While the foregoing invention has been described with reference to the above embodiments, various modifications and changes can be made without departing from the spirit of the invention. Accordingly, all such modifications and changes are considered to be within the scope of the appended claims.

What is claimed is:

1. Inorganic fiber insulation material comprising:
scrap inorganic insulation fibers; and
plastic-containing bonding fibers;
said scrap inorganic fibers and the plastic-containing bonding fibers being uniformly blended and bonded together by a portion of the plastic of said plastic-containing bonding fibers.

2. The inorganic fiber insulation material of claim 1, wherein the fiber glass insulation material has substantially uniform density throughout its volume.

3. The inorganic fiber insulation material of claim 1, wherein the scrap inorganic insulation fibers are scrap rotary glass fibers, scrap textile fibers, or both.

4. The inorganic fiber insulation material of claim 1, wherein the scrap inorganic insulation fibers have average diameter of about 1 to 10 micrometers.

5. The inorganic fiber insulation material of claim 1, wherein the scrap inorganic insulation fibers have average diameter of about 2 to 5 micrometers.

6. The inorganic fiber insulation material of claim 1, wherein the scrap inorganic insulation fibers have an average fiber length not greater than about 250 mm.

7. The inorganic fiber insulation material of claim 1, wherein the scrap inorganic insulation fibers have an average fiber length not greater than about 127 mm.

8. The inorganic fiber insulation material of claim 1, wherein the scrap inorganic insulation fibers are about 70 to 90 wt. % of the inorganic fiber insulation material.

9. The inorganic fiber insulation material of claim 1, wherein the plastic-containing bonding fibers comprise bi-component fibers.

10. The inorganic fiber insulation material of claim 9, wherein the bi-component fibers are sheath-core, side-by-side, island-in-the-sea, or segmented-pie cross-section type.

11. The inorganic fiber insulation material of claim 9, wherein the bi-component fibers comprise:
a core material; and
a sheath material, wherein the sheath material has a melting point temperature lower than the melting point temperature of the core material.

12. The inorganic fiber insulation material of claim 11, wherein the core material and the sheath material are both thermoplastic polymers.

13. The inorganic fiber insulation material of claim 11, wherein the core material is a mineral and the sheath material is a thermoplastic polymer.

14. The inorganic fiber insulation material of claim 11, wherein the core material and the sheath material are same thermoplastic polymer but of different formulations.

15. The inorganic fiber insulation material of claim 1, wherein the plastic-containing bonding fibers comprise mono-component thermoplastic polymer fibers.

16. The inorganic fiber insulation material of claim 1, wherein the plastic-containing bonding fibers have average fiber diameter of about 10 to 20 micrometers.

17. The inorganic fiber insulation material of claim 1, wherein the plastic-containing bonding fibers have average fiber diameter not greater than 16 micrometers.

18. The inorganic fiber insulation material of claim 1, wherein the plastic-containing bonding fibers are about 10 and 30 wt. % of the inorganic fiber insulation material.

19. The inorganic fiber insulation material of claim 1, wherein said inorganic fiber insulation material has a gram weight of about 310 to 2100 gm/m².

20. The inorganic fiber insulation material of claim 1, wherein said inorganic fiber insulation material has a density of about 24 to 48 kg/m³.

21. The inorganic fiber insulation material of claim 1, wherein said inorganic fiber insulation material after curing has a thickness of about 13 to 89 mm.

22. Inorganic fiber insulation product having an R-value comprising:
a final mat having a first side and a second side, the mat comprising:
loose fiber insulation-type glass fibers;
plastic-containing bonding fibers, said glass fibers and the plastic-containing bonding fibers being uniformly blended together to form a blended layer having a substantially uniform density throughout its volume, wherein the plastic-containing bonding fibers bond at least a portion of the glass fibers together; and
a facing layer bonded to at least one of the two sides of the mat.

23. The inorganic fiber insulation product of claim 22, wherein said glass fibers are scrap loose fiber insulation-type glass fibers.

24. The inorganic fiber insulation product of claim 22, wherein said glass fibers are virgin loose fiber insulation-type glass fibers and the insulation product is substantially formaldehyde-free.

25. The inorganic fiber insulation product of claim 22, wherein the facing layer is a vapor barrier.

26. The inorganic fiber insulation product of claim 22, wherein the vapor barrier is polyethylene film, kraft paper, kraft paper coated with asphalt, foil, foil-backed paper, foil-backed paper coated with asphalt, or flame-resistant foil-scrim-kraft paper.

27. The inorganic fiber insulation product of claim 22, wherein the facing layer is made from a scrim, woven, non-woven, knit, braided, needled, or composite fabric.

28. The inorganic fiber insulation product of claim 27, wherein the fabric layer is treated with water resistant additive made from epoxy foam, acrylic, or asphalt.

29. The inorganic fiber insulation product of claim 22, wherein said glass fibers are scrap rotary glass fibers, scrap textile fibers or a combination thereof.

30. The inorganic fiber insulation product of claim 22, wherein said glass fibers have average diameter of about 1 to 10 micrometers.

31. The inorganic fiber insulation product of claim 22, wherein said glass fibers have average diameter of about 2 to 5 micrometers.

32. The inorganic fiber insulation product of claim 22, wherein said glass fibers have an average fiber length not greater than about 250 mm.

33. The inorganic fiber insulation product of claim 22, wherein said glass fibers have an average fiber length not greater than about 127 mm.

34. The inorganic fiber insulation product of claim 22, wherein said glass fibers comprise about 70 to 90 wt. % of the final mat.

35. The inorganic fiber insulation product of claim 22, wherein the plastic-containing bonding fibers comprise bi-component fibers.

36. The inorganic fiber insulation product of claim 22, wherein the plastic-containing bonding fibers comprise mono-component thermoplastic polymer fibers.

37. The inorganic fiber insulation product of claim 35, wherein the bi-component fibers are sheath-core, side-by-side, island-in-the-sea, or segmented-pie cross-section type.

38. The inorganic fiber insulation product of claim 35, wherein the bi-component fibers comprise:
a core material; and
a sheath material, wherein the sheath material has a melting point temperature lower than the melting point temperature of the core material.

39. The inorganic fiber insulation product of claim 38, wherein the core material and the sheath material are both thermoplastic polymers.

40. The inorganic fiber insulation product of claim 38, wherein the core material is a mineral and the sheath material is a thermoplastic polymer.

41. The inorganic fiber insulation product of claim 38, wherein the core material and the sheath material are same thermoplastic polymer but of different formulations.

42. The inorganic fiber insulation product of claim 22, wherein the plastic-containing bonding fibers have average fiber diameter of about 10 to 20 micrometers.

43. The inorganic fiber insulation product of claim 22, wherein the plastic-containing bonding fibers have average fiber diameter not greater than 16 micrometers.

44. The inorganic fiber insulation product of claim 22, wherein the plastic-containing bonding fibers are about 10 and 30 wt. % of the final mat.

45. The inorganic fiber insulation product of claim 22, wherein said inorganic fiber insulation product has a gram weight of about 310 to 2100 gm/m².

46. The inorganic fiber insulation product of claim 22, wherein said inorganic fiber insulation product has a density of about 24 to 48 kg/m³.

47. The inorganic fiber insulation product of claim 22, wherein said inorganic fiber insulation product after curing has a thickness of about 13 to 89 mm.

48. The inorganic fiber insulation product of claim 22, wherein the R-value is between about 2.0 to 3.5 per inch.

49. A method of making an inorganic fiber insulation product, comprising the steps of:
opening bulk inorganic fibers and bulk plastic-containing bonding fibers;
blending said opened inorganic fibers and said plastic-containing bonding fibers into blended fibers;
forming said fiber blend into a mat having a first side and a second side;
applying a facing layer to at least one of said two sides of the mat; and
curing or heating said mat and said facing layer into said fiber glass insulation product.

50. The method of claim 49, wherein said inorganic fibers comprise scrap rotary fibers, scrap textile fibers or both.

51. The method of claim 49, wherein said inorganic fibers comprise virgin rotary fibers, virgin textile fibers or both.

52. The method of claim 49, wherein said step of opening further comprises a step of weighing said opened fibers to monitor the feed rate of said opened fibers.

53. The method of claim 52, wherein said step of forming said fiber blend into said mat further comprising continuously weighing said mat to ensure that the flow rate of the blended fibers is at a desired rate.

54. The method of claim 53, further comprising a step of comparing the feed rate of said opened fibers and the flow rate of said blended fibers in a feed back loop to control the speed of said opening step.

55. The method of claim 49, wherein said curing or heating step comprises curing or heating said mat at a temperature of less than about 200° C.
